(19) United States
(12) Patent Application Publication
(10) Pub. No.: US 2009/0185462 A1
(43) Pub. Date: Jul. 23, 2009

(54) Focus Controller and Focus Control Method

(75) Inventors: Gwo-Huei Wu, Pan-Chiao City (TW); Chih-Yuan Chen, Chu-Pei City (TW); Yuh Cheng, Chu-Pei City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 12/355,298

(22) Filed: Jan. 16, 2009

(30) Foreign Application Priority Data
Jan. 18, 2008 (TW) 097101957

(51) Int. Cl. G11B 7/00

(52) U.S. Cl. 369/44.32; G9B/7

(57) ABSTRACT

A focus controller and a focus control method are provided. The method allows the optical access apparatus focus from a current data layer onto a target layer. Each of the current layer and the target layer corresponds to a Spherical Aberration Compensation (SAC) value and a focus error related parameter. The method adjusts the SAC value in use to a temporary SAC value, adjusts the focus error related parameter in use to a temporary focus error related parameter, focuses on the target layer, adjusts the focus error related parameter in use to the focus error related parameter corresponding to the target layer, and adjusts the SAC value in use to the focus error related parameter corresponding to the target layer.

This application claims the benefit from the priority of Taiwan Patent Application No. 097101957 filed on Jan. 18, 2008, the disclosure of which is incorporated herein by reference in its entirety.

### CROSS-REFERENCES TO RELATED APPLICATIONS

Not applicable.

### BACKGROUND OF THE INVENTION

1. Field of the Invention

The present invention relates to a focus control method and a focus controller; and more particularly, this invention relates to a focus control method and a focus controller that allows rapid focusing as well as stably accessing data when changing from one layer to another layer of an optical storage medium.

2. Descriptions of the Related Art

With the rapid development of the flourishing market for optical access apparatus (e.g., optical disc drives), various optical access apparatuses have become increasingly sophisticated in functionality. Efforts in technical development have been focused on apparatuses that are capable of stably accessing data, reducing focusing error, and shortening target data searching time.

FIG. 1 illustrates how an optical access apparatus accesses data on an optical storage medium 10 according to the related art. The optical storage medium 10 comprises two data layers, namely, a first data layer 101 and a second data layer 103. The pick-up head of the optical access apparatus comprises a focusing device 113 and a spherical aberration (SA) compensator 115. The focusing device 113 is adapted to focus a laser beam 111 onto the first data layer 101 or the second data layer 103 to access data thereon, while the SA compensator 115 is adapted to compensate for the optical spherical aberration.

As depicted in FIG. 1, the laser beam 111 is focusing onto the second data layer 103 to access data thereon. When the optical access apparatus attempts to access the first data layer 101, a readjustment should be made on both the focusing device 113 and the SA compensator 115 in a way that the laser beam 111 will be re-focused precisely onto the first data layer 101. However, changing the accessing layer involves a number of mechanical or electronic components, which may influence the data accessing speed and stability of the optical access apparatus, especially for optical access apparatuses of high-density optical storage media such as a blue-ray disc drive. Accordingly, it is highly desirable in the art to effectively reduce the time needed to re-focus and compensate for the spherical aberration, while still stably access the data when changing accessing layers.

### SUMMARY OF THE INVENTION

One objective of this invention is to provide a focus control method for making an optical access apparatus focus from a current data layer onto a target data layer of an optical storage medium. Each of the current data layer and the target data layer has an adequate Spherical Aberration Compensation (SAC) value and a focus error related parameter. The method comprises the following steps: (a) adjusting an SAC value in use to a temporary SAC value; (b) adjusting a focus error related parameter in use to a temporary focus error related parameter; (c) focusing on the target data layer; (d) adjusting the SAC value to the SAC value adequate for the target data layer; and (e) adjusting the focus error related parameter to the focus error related parameter adequate for the target data layer.

Another objective of this invention is to provide a focus controller for an optical access apparatus. The focus controller is configured to change the focus from a current data layer to a target data layer of an optical storage medium. Each of the current data layer and the target data layer has an adequate SAC value and a focus error related parameter. The focus controller comprises a control module, a compensation value adjustment module, and a parameter adjustment module. The control module is configured to control the optical access apparatus to focus on the target data layer. The compensation value adjustment module is configured to adjust the SAC value. The parameter adjustment module is configured to adjust the focus error related parameter. During a process of focusing from the current data layer onto the target data layer, the compensation value adjustment module adjusts the SAC value in use by the optical access apparatus to a temporary SAC value, while the parameter adjustment module adjusts the focus error related parameter in use by the optical access apparatus to a temporary focus error related parameter. During a pre-determined time interval that the control module controls the optical access apparatus to focus on the target data layer, the compensation adjustment module adjusts the SAC value in use by the optical access apparatus to the SAC value adequate for the target data layer, while the parameter adjustment module adjusts the focus error related parameter in use by the optical access apparatus to the focus error related parameter adequate for the target data layer.

With the appropriate adjustments of the SAC value and the focus error related parameter, this invention is able to effectively reduce the time needed to change from one data layer to another and to ensure stable data accessing during the layer changing process.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating how an optical access apparatus reads data on an optical storage medium according to the related art;

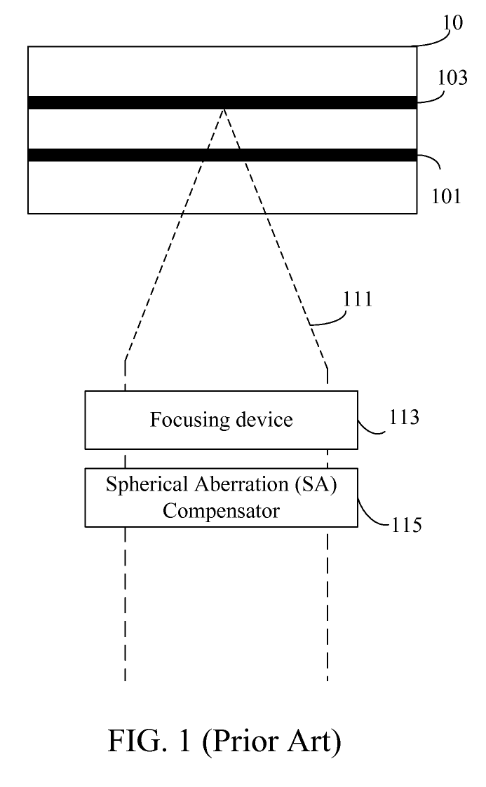

FIG. 2 is a schematic view of a first embodiment of this invention;

FIG. 3 is a graph of a SAC value versus a peak-to-peak value of an S-curve;

FIG. 4A depicts a schematic view of a layer changing process taking vertical wobbling into account;

FIG. 4B depicts another schematic view of a layer changing process taking vertical wobbling into account;

FIG. 5A schematically depicts a process for changing from a data layer L0 to a data layer L4 on a step-by-step basis;

FIG. 5B schematically depicts a process for changing from a data layer L0 to a data layer L4 directly; and

FIG. 6 is a flow diagram of a second embodiment of this invention.

### DESCRIPTION OF THE PREFERRED EMBODIMENT

In the following description, this invention will be explained with reference to embodiments thereof, which relate to a focus control method and a focus controller. By appropriately arranging the occasions to adjust the SAC value and the focus error related parameter, this invention is able to effectively reduce the time needed to change from one data layer to another and render the data accessing more stable during the layer changing process.

However, these embodiments are not intended to limit that this invention can only be embodied in any specific context, applications or with particular implementations described in these embodiments. Therefore, description of these embodiments is only intended to illustrate rather than to limit this invention. It should be appreciated that in the following embodiments and the attached drawings, elements indirectly related to this invention are omitted from depiction, and dimensional relationships among individual elements are depicted in an exaggerated way to facilitate understanding.

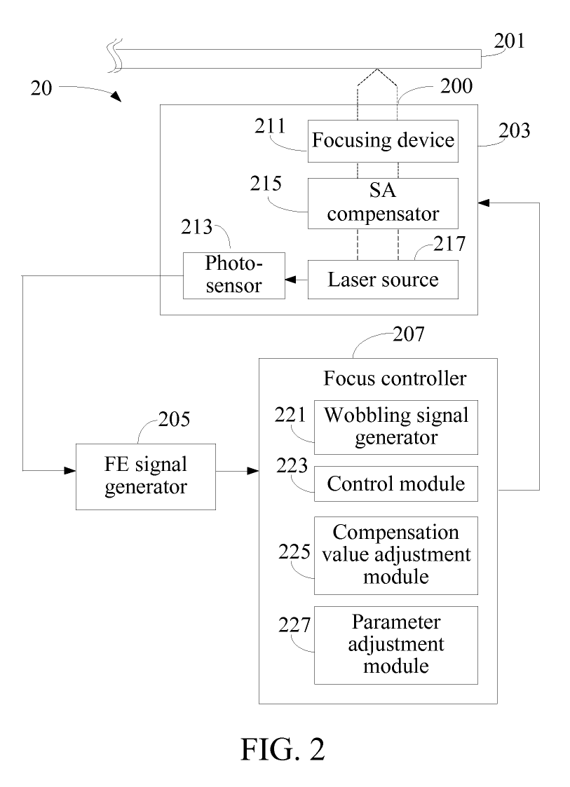

A first embodiment of this invention is an optical access apparatus 20 as depicted in FIG. 2. The optical access apparatus 20 comprises an optical pick-up head 203, a focus error (FE) signal generator 205, and a focus controller 207. The optical pick-up head 203 comprises a focusing device 211, a photo-sensor 213, a spherical aberration (SA) compensator 215, and a laser source 217. The FE signal generator 205 generates an FE signal for controlling the focus in response to a reflection signal sensed by the optical pick-up head. The focus controller 207 comprises a wobbling signal generator 221, a control module 223, a compensation value adjustment module 225, and a parameter adjustment module 227.

The optical access apparatus 20 can be used to access an optical storage medium 201. During the accessing process, the accessing operation may change from a current data layer to a target data layer of the optical storage medium 201; that is, the focus may be switched from the current data layer to the target data layer. Since each of the current data layer and the target data layer has an adequate SAC value and an adequate focus error related parameter, the SAC value and the focus error related parameter in use by the optical access apparatus 20 must be adjusted during the layer changing process to access the data correctly.

Each of the focus error related parameters set forth herein may respectively comprise one of a Focus Error Gain (FEG) value, a Focus Error Offset (FEO) value, or a combination thereof. To be more specific, the FE signal generator 205 generates an FE signal in response to a reflection light reflected from the optical storage medium 201. The FE signal comprises an S-curve corresponding to the target data layer and an S-curve corresponding to the current data layer, and both of which have a peak-to-trough value. The FEG value is used to amplify the FE signal so that the peak-to-trough value of the S-curve of the target layer will not fall out of a certain range, and the FEO value is used to offset a central value of the S-curve corresponding to the current data layer so that the central value of the FE signal can operate within a certain range. This is well known to those of ordinary skill in the art, and thus will not be further described herein.

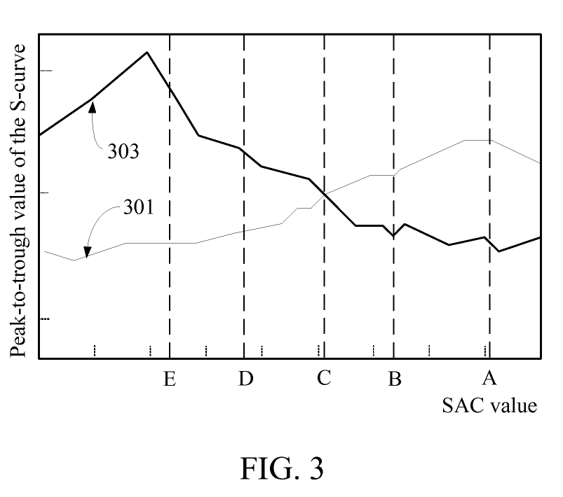

Prior to the detailed description of how the optical access apparatus 20 of this invention changes the accessing operation from one data layer to another, please refer to FIG. 3 for a graph of an SAC value versus a peak-to-trough value of an S-curve. Here, the horizontal coordinate represents the SAC value, while the vertical coordinate represents the peak-to-trough value of the S-curve. Curve 301 corresponds to the current data layer, while curve 303 corresponds to the target data layer. The optical access apparatus 20 adopts the SAC value A that is adequate for the current data layer when reading the current data layer, but adopts the SAC value E that is adequate for the target data layer when reading the target data layer.

Next, the process for the optical access apparatus 20 to change the accessing operation from one data layer to another will be described. The compensation value adjustment module 225 of the focus controller 207 adjusts the SAC used by the optical access apparatus 20 (i.e., the SAC value A adequate for the current data layer) to a temporary SAC value C. The temporary SAC value C may be an average of the SAC value A corresponding to the current data layer and the SAC value E corresponding to the target data layer.

Since the peak value of the S-curve of the current data layer corresponding to the temporary SAC value C becomes smaller, the focus error related parameter currently in use has to be appropriately adjusted to a temporary focus error related parameter to maintain a stable focusing servo when changing the data accessing layer. Each of the focus error related parameters in use and the temporary focus error related parameter may an FEG value, an FEO value, or the combination thereof. If the focus error related parameter in use is an FEG value, the temporary focus error related parameter will be an FEG value too. Likewise, if the focus error related parameter in use is an FEO value, the temporary focus error related parameter will also be an FEO value. Furthermore, if the focus error related parameter in use incorporates both the FEG and the FEO values, the temporary focus error related parameter will incorporate both values too.

More specifically, since the peak value of the S-curve of the current data layer corresponding to the temporary SAC value C becomes smaller, the FEG value has to be appropriately increased to maintain a stable focusing servo when changing the data accessing layer. One approach for determining the appropriate temporary FEG value is to calculate the FEG values corresponding to the temporary SAC value C of the current data layer and the target data layer respectively and then average the two values. Another approach is to choose either the FEG value of the current data layer or that of the target data layer. Additionally, a central value of the S-curve generally varies with the SAC value, so the FEO value in use has to be adjusted to the appropriate FEO value as well. One approach for determining the appropriate temporary FEO value is to calculate the FEO values corresponding to the temporary SAC value C of the current data layer and the target data layer respectively and then to average the values. Another approach is to choose either the FEO value of the current data layer or that of the target data layer. In this embodiment, both parameters are determined by the parameter adjustment module 227.

Next, the control module 223 controls the optical access apparatus 20 to change the focusing layer to the target data layer. Since neither the temporary SAC value C nor the temporary focus error related parameter is adequate for the target data layer, a further adjustment has to be made. Therefore, upon focusing on the target data layer, the parameter adjustment module 227 adjusts the focus error related parameter in use by the optical access apparatus 20 (i.e., the temporary focus error related parameter) to the focus error related parameter adequate for the target data layer, while the compensation value adjustment module 225 adjusts the SAC value in use by the optical access apparatus 20 (i.e., the temporary SAC value C) to an SAC value E adequate for the target data layer. Likewise, the focus error related parameter adequate for the target data layer may comprise an FEG value, an FEO value, or a combination thereof. Thus, the optical access apparatus 20 completes the process of changing the focusing operation from a current data layer to a target data layer.

It should be emphasized that in other examples, the temporary SAC value C is not merely limited to the average value of the SAC value A and SAC value E corresponding to the current data layer and the target data layer respectively. Other temporary SAC value C may also be chosen provided that a difference between the FEG values corresponding to the chosen temporary SAC value and the current data layer respectively is greater than a predetermined value; for example, the SAC value B or D may also be chosen as a temporary SAC value.

It should also be emphasized that, as shown in FIG. 2, the focus controller in other embodiments may control the optical access apparatus 20 to first adjust the SAC value to a temporary SAC value B and then adjust the focus error related parameter to a value corresponding to the temporary SAC value B. Then, the SAC value is adjusted to a temporary SAC value C. Similarly, the focus error related parameter is adjusted to a value corresponding to the temporary SAC value C. Subsequently, the SAC value is further adjusted to a temporary SAC value D. Meantime, the focus error related parameter is adjusted to the value corresponding to the temporary SAC value D. The operation of focusing from one data layer onto another may be implemented while the SAC value is being adjusted to any of the temporary SAC values, after which the temporary focus error related parameter and the temporary SAC value are adjusted to the focus error related parameter and the SAC value adequate for the target data layer respectively.

Vertical wobbling may occur in the rotating optical storage medium 201 when being accessed by the optical access apparatus 20. The first embodiment may further take the vertical wobbling into account by choosing a time point in which the target data layer should be focused. More specifically, the wobbling signal generator 221 detects a vertical wobbling direction of the optical storage medium 201. The control module 223 determines whether the vertical wobbling direction of the optical storage medium 201 is in a predetermined direction before focusing on the target data layer. If the vertical wobbling direction is in the predetermined direction, the focusing operation will change the focus onto the target data layer. More specifically, when a direction from the current data layer to a target data layer is directed upwards, the predetermined direction is set to be the same as the moving direction, in which case a minimum relative velocity exists between the spherical aberration compensator 215 and the optical storage medium 201 to enhance the capability of stable focusing during the layer changing process.

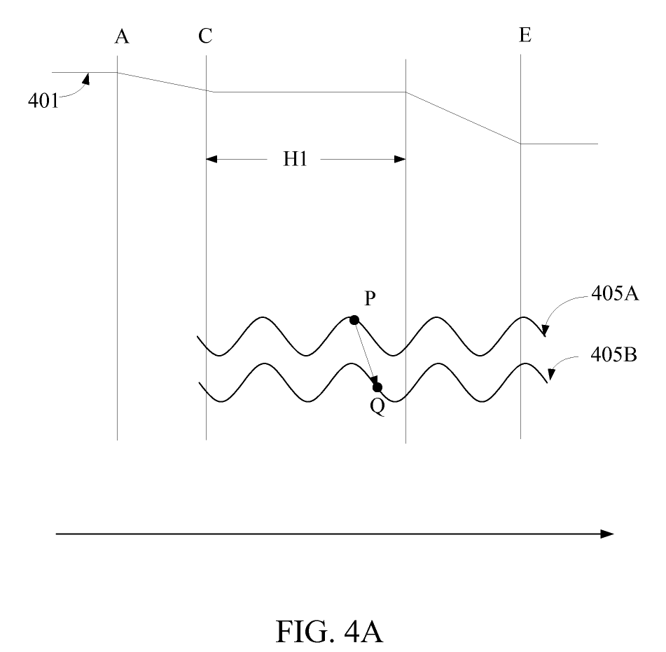

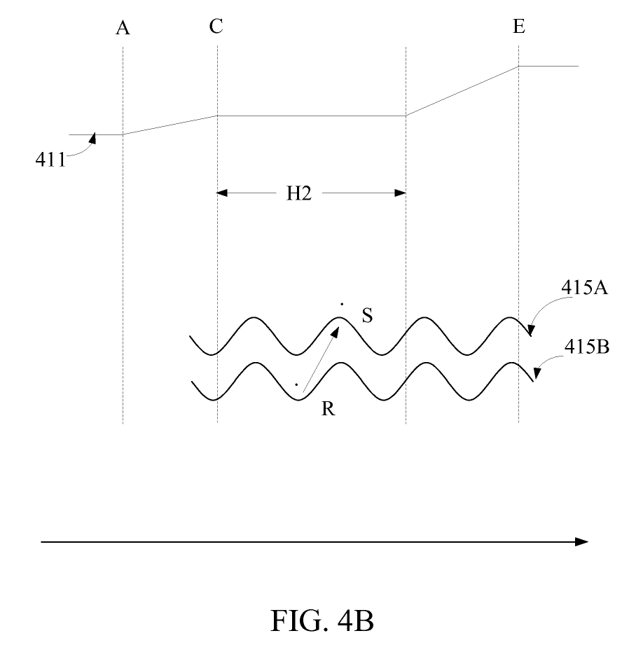

Hereinafter, a layer changing process which takes the vertical wobbling into account will be detailed with reference to FIG. 4A, wherein the horizontal axis represents time. FIG. 4A depicts the SAC value 401, the vertical wobbling 405A of the current data layer, and the vertical data layer 405B of the target data layer prior to, during, and subsequent to the layer changing process.

Once the SAC value 401 decreases to the temporary SAC value C or to a value within a certain range H1 from the temporary SAC value C as shown in FIG. 4A, the layer changing process can be implemented by taking the vertical wobbling into account. If the target data layer is positioned closer to the focusing device 211 than the current data layer, the layer changing process may commence when the optical storage medium 201 is about to approach the focusing device 211 during the vertical wobbling (e.g., at a point P in FIG. 4A), i.e., when the vertical wobbling direction is consistent with the layer changing direction. In one embodiment of this invention, if the SAC value has been adjusted to a predetermined temporary SAC value before changing the focus onto the target data layer, the temporary SAC value will be maintained until the completion of the layer changing process. After the layer changing process has been complete, the adjustment will be made to make the SAC value adequate for the target data layer. During the layer changing process, the focus controller 207 generates a focus control signal for lowering the focus position, so that the beam 200 is focused towards the target data layer. As the focus point of the beam 200 approaches the target data layer, the focus controller 207 decelerates the lens of the focusing device so that the beam 200 can be precisely focused onto the target data layer which corresponds to the point Q in the vertical wobbling curve 405B. Subsequently, the SAC value 401 continues to decrease until it reaches an SAC value E.

In FIG. 4B, once the SAC level 411 is changed to the temporary SAC value C or within a certain range H2 of the temporary SAC value C as shown in FIG. 4B, the layer changing process can be implemented by taking the vertical wobbling into account. If the current data layer is positioned closer to the focusing device 211 than the target data layer, the layer changing process may be commenced when the optical storage medium 201 is about to move away from the focusing device 211 because of the vertical wobbling (e.g., at a point R in FIG. 4B), i.e., when the vertical wobbling direction is consistent with the layer changing direction. In an embodiment of this invention, if the SAC value has been adjusted to a predetermined temporary SAC value before changing the focus onto the target data layer, the temporary SAC value will be maintained until the completion of the layer changing process. After the layer changing process has been completed, an adjustment will be made on the SAC value. During the layer changing process, the focus controller 207 generates a focus control signal for raising the focus position, so that the beam 200 is focused towards the target data layer. As the focus point of the beam 200 approaches the target data layer, the focus controller 207 decelerates the lens of the focusing device 211 so that the beam 200 can be precisely focused onto the target data layer which corresponds to a point S in the vertical wobbling curve 405B. Subsequently, the SAC value 401 continues to decrease until it reaches a point E.

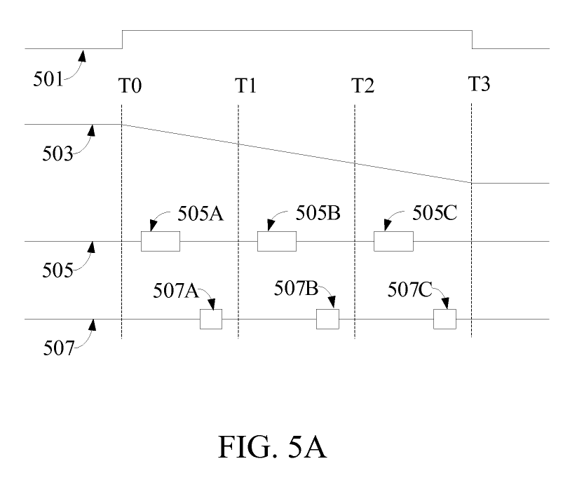

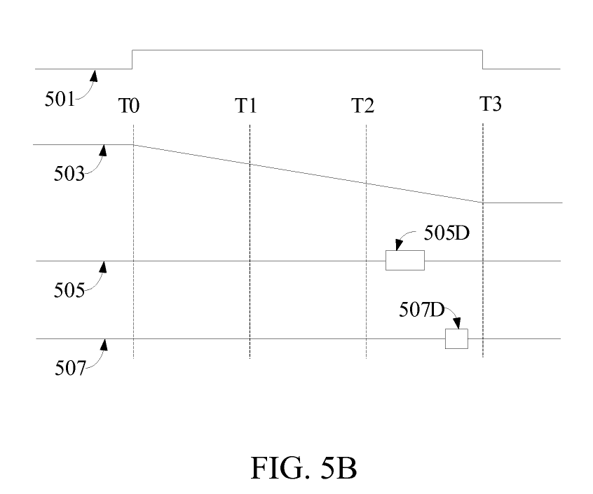

FIG. 5A further schematically depicts a process for changing from a data layer L0 (i.e., a current data layer) to a data layer L3 (i.e., a target data layer) when the optical storage medium 201 has four data layers L0, L1, L2 and L3. The horizontal axis represents time, 501 represents presence/absence of a layer changing status, 503 represents a level of the SAC value, 505 represents time intervals in which the focus error related parameter is adjusted, and 507 represents time intervals in which the layer changing process is implemented.

Likewise, each of the data layers L0, L1, L2, and L3 has an adequate SAC value and an adequate focus error related parameter, in which the SAC values adequate respectively for the data layers L0, L1, L2 and L3 descend in order.

When it is time to change the data layer at a time point T0, the signal 501 transits to a high level. The compensation value adjustment module 225 then decreases the SAC value 503 continuously. During the time interval 505A, the parameter adjustment module 227 adjusts the focus error related parameter used by the optical access apparatus 20 (i.e., the focus error related parameter adequate for the data layer L0) to a first temporary focus error related parameter (e.g., an intermediate value between the focus error related parameter adequate for the data layer L0 and the focus error related parameter adequate for the data layer L1), and then during a time interval 507A, the control module 223 controls the optical access apparatus 20 to focus on the data layer L1.

Similarly, when it is time to change the data layer at a time point T1, the compensation value adjustment module 225 decreases the SAC value 503 continuously. During the time interval 505B, the parameter adjustment module 227 adjusts the focus error related parameter used by the optical access apparatus 20 from the first temporary focus error related parameter to a second temporary focus error related parameter (e.g., an intermediate value between the focus error related parameter corresponding to the data layer L1 and the focus error related parameter corresponding to the data layer L2). Then, during the time interval 507B, the control module 223 controls the optical access apparatus 20 to focus on the data layer L2.

Next, when it is time to change the data layer at a time point T2, the compensation value adjustment module 225 decreases the SAC value 503 continuously. During the time interval 505C, the parameter adjustment module 227 adjusts the focus error related parameter used by the optical access apparatus 20 from the second temporary focus error related parameter to a third temporary focus error related parameter (e.g., an intermediate value between the focus error related parameter corresponding to the data layer L2 and the focus error related parameter corresponding to the data layer L3). Then, during a time interval 507C, the control module 223 controls the optical access apparatus 20 to focus on the data layer L3. At this point, the signal 501 transits to a low level, and the SAC value 503 stops changing the value. Thus, the process of changing the focusing operation from the data layer L0 to the data layer L3 is completed at a time point T3.

In optical storage media with multiple data layers, other embodiments of this invention may also change the focusing operation from a current data layer to a target data layer directly instead of on a layer-by-layer basis. Referring to FIG. 5B, the change of the focusing operation to another data layer and the adjustment of the focus error related parameter would not be implemented in a time interval between the time point T1 and the time point T2. After the time point T2, the focus error related parameter is adjusted to an adequate temporary focus error related parameter in a time interval 505D, e.g., an intermediate value between a focus error related parameter corresponding to the data layer L2 and a focus error related parameter corresponding to the data layer L3. Then, during a time interval 507D, the control module 223 controls the optical access apparatus 20 to focus on the data layer L3.

The second embodiment of this invention is a focus control method, a flow diagram of which is depicted in FIG. 5. The focus control method is adapted to make an optical access apparatus focus from a current data layer onto a target data layer of an optical storage medium. Each of the current data layer and the target data layer has an SAC value and a focus error related parameter.

The focus control method begins with step 601, where an SAC value currently used by an optical access apparatus is adjusted to a temporary SAC value. Then, step 603 is executed to adjust a focus error related parameter currently used by the optical access apparatus to a temporary focus error related parameter. Step 605 is executed to focus on the target data layer. Next, step 607 is executed to adjust the focus error related parameter currently used by the optical access apparatus to a focus error related parameter corresponding to the target data layer. Finally, step 609 is executed to adjust the SAC value to the SAC value corresponding to the target data layer, thus completing the layer changing process.

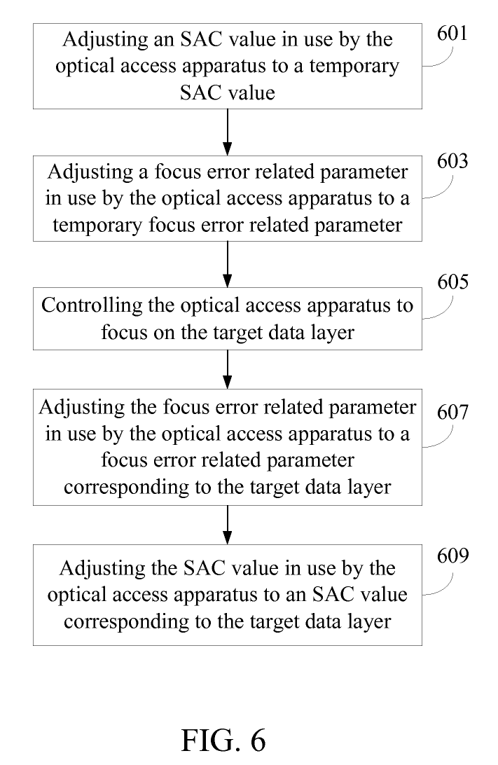

In addition to the steps depicted in FIG. 6, the second embodiment may also execute all the operations and functions of the first embodiment. Those of ordinary skill in the art may readily understand how the second preferred embodiment executes these operations and functions based on descriptions of the first preferred embodiment. Thus, this will not be further described again herein.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A focus control method for making an optical access apparatus focus from a current data layer onto a target data layer of an optical storage medium, each of the current data layer and the target data layer having an adequate Spherical Aberration Compensation (SAC) value and a focus error related parameter, the method comprising the steps of:
adjusting an SAC value in use to a temporary SAC value;
adjusting a focus error related parameter in use to a temporary focus error related parameter;
focusing on the target data layer;
adjusting the focus error related parameter to the focus error related parameter adequate for the target data layer; and
adjusting the SAC value to the SAC value adequate for the target data layer.

2. The method as claimed in claim 1, wherein each of the focus error related parameters respectively comprises one of a Focus Error Gain (FEG) value, a Focus Error Offset (FEO) value, and the combination thereof.

3. The method as claimed in claim 1, further comprising the steps of:
determining a vertical wobbling direction of the optical storage medium being a pre-determined direction before focusing on the target data layer.

4. The method as claimed in claim 3, wherein the pre-determined direction and a direction from the current data layer to the target data layer have a minimum relative velocity.

5. The method as claimed in claim 1, wherein the temporary SAC value is an average of the SAC value adequate for the current data layer and the SAC value adequate for the target data layer.

6. The method as claimed in claim 1, wherein each of the focus error related parameters respectively comprises an FEG value, a temporary FEG value of the temporary focus error related parameter is one of the FEG value of the target data layer, the FEG value of the current data layer, and an average of the FEG value of the target data layer and the FEG value of the current data layer.

7. The method as claimed in claim 1, wherein each of the focus error related parameters comprises an FEO value, a temporary FEO value of the temporary focus error related parameter is one of the FEO value of the current data layer, the FEO value of the target data layer, and an average of the FEO value of the current data layer and the FEO value of the target data layer.

8. A focus controller for an optical access apparatus to focus from a current data layer onto a target data layer of an optical storage medium, each of the current data layer and the target data layer having an adequate SAC value and a focus error related parameter, the focus controller comprising:
a control module, being configured to control the optical access apparatus to focus on the target data layer;
a compensation value adjustment module, being configured to adjust an SAC value; and
a parameter adjustment module, being configured to adjust a focus error related parameter;
wherein during a process of focusing from the current data layer onto the target data layer, the compensation value adjustment module adjusts the SAC value in use by the optical access apparatus to a temporary SAC value and the parameter adjustment module adjusts the focus error related parameter in use by the optical access apparatus to a temporary focus error related parameter, and during a pre-determined time interval that the control module controls the optical access apparatus to focus on the target data layer, the parameter adjustment module adjusts the focus error related parameter used by the optical access apparatus to the focus error related parameter adequate for the target data layer and the compensation adjustment module adjusts the SAC value used by the optical access apparatus to the SAC value adequate for the target data layer.

9. The focus controller as claimed in claim 8, wherein each of the focus error related parameters respectively comprises one of an FEG value, an FEO value, and the combination thereof.

10. The focus controller as claimed in claim 8, wherein the control module is further configured to determine a vertical wobbling direction of the optical storage medium being a pre-determined direction before focusing on the target data layer.

11. The focus controller as claimed in claim 10, wherein the pre-determined direction and a direction from the current data layer to the target data layer have a minimum relative velocity.

12. The focus controller as claimed in claim 8, wherein the temporary SAC value is an average of the SAC value adequate for the current data layer and the SAC value adequate for the target data layer.

13. The focus controller as claimed in claim 8, wherein each of the focus error related parameter respectively comprises an FEG value, a temporary FEG value of the temporary focus error related parameter is one of the FEG value of the target data layer, the FEG value of the current data layer, and an average of the FEG value of the target data layer and the FEG value of the current data layer.

14. The focus controller as claimed in claim 8, wherein each of the focus error related parameter respectively comprises an FEO value, a temporary FEO value of the temporary focus error related parameter is one of the FEO value of the current data layer, the FEO value of the target data layer, and an average of the FEO value of the current data layer and the FEO value of the target data layer.
